(19) United States
(12) Patent Application Publication
(10) Pub. No.: US 2004/0205591 A1
(43) Pub. Date: Oct. 14, 2004

(54) Method and program for XML data conversion

(75) Inventor: Masaaki Nagao, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/224,086

(22) Filed: Aug. 19, 2002

(30) Foreign Application Priority Data
Oct. 30, 2001 (JP) 2001-331851

(51) Int. Cl. G06F 15/00; G06F 17/24

(52) U.S. Cl. 715/513; 715/514

(57) ABSTRACT

A method of processing a general-purpose XML document is executed to generate mapping data as a variable in a variable buffer when an input XML document is inputted through the effect of an input mapping function of a processing processor of a script language. When the output mapping function is started, the output XML document is supplied from the mapping data in the variable buffer.

### BACKGROUND OF THE INVENTION

The present invention relates to a function of processing an XML document in the script language, and more particularly to a method of processing each tag data unit of the XML document as a variable of the script language.

As the script language used for building a Web application, the Java server page, Perl and so forth may be referred. In this type of Web application system, when a terminal requests the display data of the Web contents of a server, the server operates to generate the data in the HTML format by using a script file. The script file includes a description of a script for supplying the HTML form data and a description of a script for supplying the data drawn out of a database as the HTML form data. This makes it possible to generate the display data on which the content of the database is reflected. The server operates to send the display data to the terminal.

In recent days, the XML document (also called the XML data) is used for the I/O data form of the database. As a background art of handling the XML document, for example, the JP-A-2000-122903 describes application of the XML document to a relational database by describing mapping of a DTD (Document Type Definition) element where the XML document structure is disclosed.

In the case of doing mapping through the background art, it is necessary to define the structure of the XML data for DTD.

### SUMMARY OF THE INVENTION

It is an object of the present invention to provide a method of processing the XML document in more general-purpose manner.

One of the means of achieving the foregoing object is the method of extracting data from the inputted XML data with reference to a specific character and converting the extracted XML data into a variable on the basis of the predetermined rules.

Other objects, features and advantages of the invention will become apparent from the following description of the embodiments of the invention taken in conjunction with the accompanying drawings.

### BRIEF DESCRIPTION OF THE DRAWINGS

FIG. 1 is a view showing a server of processing an XML document in the script language according to an embodiment of the present invention;

FIG. 2 is a diagram showing an example of a summary of a Web application system;

FIG. 3 is a table showing an example of mapping rules on a member name;

FIG. 4 is a table showing an example of generated variables for the XML document;

FIG. 5 is a flowchart showing an example of a process of an input mapping function;

FIG. 6 is a flowchart showing an example of a process of an output mapping function;

FIG. 7 is a chart showing an example of XML data including a plurality of names and addresses;

FIG. 8 is a chart showing an example of a script file obtained by processing the XML data and to be supplied as the HTML data;

FIG. 9 is a view showing an example of a display of Web contents;

FIG. 10 is a chart showing an example of a script file for entering the data entered on an input field of a browser onto a database;

FIG. 11 is a chart showing an example of a script file for supplying the XML data; and

FIG. 12 is a chart showing an example of a script file for supplying the XML data.

### DESCRIPTION OF THE EMBODIMENTS

Hereafter, an embodiment of the invention will be described in detail with reference to the appended drawings.

The terms used in this specification, such as XML, node, tag, parent tag, child tag, ancestor tag, start tag, end tag, route tag, text, and comments, follow the definition of the terms in the XML specification of the W3C (the World Wide Web Consortium).

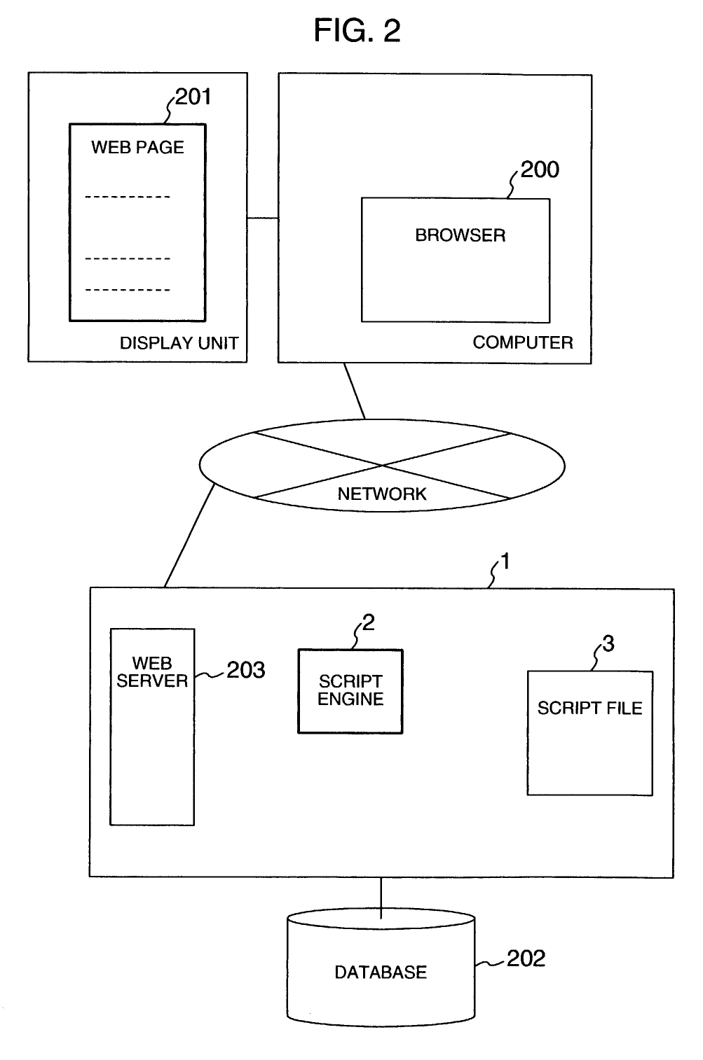

FIG. 2 illustrates an example of a Web application system. In this system, when a browser 200 accesses a WWW server 203 located in a server unit 1 connected to the internet for requesting the display data of the Web contents, the WWW server 203 starts a script engine 2 that is served as a processing processor of a script language. The script engine 2 generates the XML form data on which the latest data of a database 202 is reflected by using a script file 3 and the database 202. This XML form data is displayed as Web contents 201 onto the display unit by means of the browser 200.

Conversely, when the data of the database 202 is updated on the data inputted into the browser 200, the script engine 2, which has received the request of the display data of the Web contents and the updated data from the browser 200, stores the updated data as a variable. Then, the script engine 2 operates to load the script file 3 for updating the data and execute it. The description of this script file 3 makes it possible to convert the variable into the data form of the database, output the converted variable into the database 202 and give back the display data of the Web contents for indicating the data-updated result to the browser 200.

In addition, the browser 200 is a program including a function of the browser. The WWW server 203 is a program including a WWW server function. The script engine 2 is a program of generating the XML form data by using the script file 3 and the database 202.

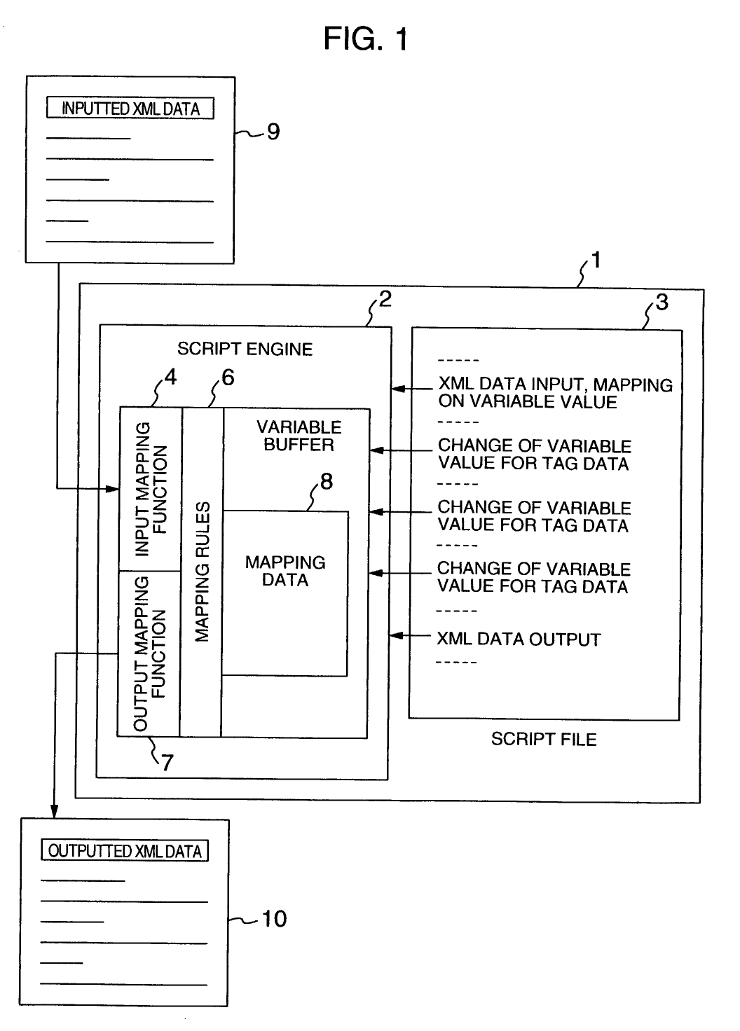

FIG. 1 is a view showing a portion of the script engine and the script file shown in FIG. 2 in detail.

The structure indicated herein makes it possible to generate the mapping data through the use of the XML data and the mapping rules. That is, the structure is arranged to generate the mapping data directly from the XML data.

The script engine 2 is a process of reading the script file 3 one script by one script. By invoking the input mapping function of the XML data described on the script file 3, the script engine 2 operates to read the input XML data 9, generate a unique variable name to each tag, and set the tag data to the variable value. This makes it possible to hold the mapping data 8 as a variable in the variable buffer. After the input mapping function 4 is invoked, the variable is handled. Then, by invoking the output mapping function 7, the script engine 2 operates to obtain the variable and the variable value included in the XML data from the content of the mapping data 8 in the variable buffer at a time, and then to generate the output XML data 10 based on the information.

It is to be understood from the flow of the foregoing process that the function of processing the XML data through the script language is composed of an input mapping function 4, an output mapping function 7 and their mapping rules 6 on the script engine 2.

At first, the mapping rules 6 will be described below.

By the way, though the XML data structure is constant, the variables and their data structures to be used for a script language are respective in each script language. Hence, the mapping rule is made variable according to the specification of the script language. The script language treated herein has a specification in which an array variable of a structure is to be treated. The array variable of the structure has the following description form.

$variable name. member name [array index]=value

The mapping rule 6 on the array variable of the structure is a definition of a relation among a node and node information in the XML data, a variable name in the script language, a member name, an array index, and a member variable value. Hereafter, the mapping rules 6 will be described in the sequence of the variable name, the member name, the member variable value, and the array index.

The mapping rule 6 on the variable name is a variable name for any one tag of the XML data. Hence, it must be a unique variable name to each tag.

A program that is arranged to specify a value to a variable and then output the XML data is able to specify any variable name if it is a unique one when the program is being programmed.

On the other hand, in the case of entering the XML data and editing the program, the variable name has to be automatically generated. In this case, the two conditions of automatically generating the variable name may be provided. As the first condition, it is a value to be used as a variable name. As the second condition, it is a unique variable name to each tag.

In a case that for the first condition a numeric value may be used for the variable name, in order to meet the second condition, it may be a unique variable name by delimiting the array index from the route tag with a delimiter. Further, in a case that the readability of the variable name is ameliorated by adding a tag name from the route tag, the variable name will be as follows.

$route tag name; ˜; ancestor tag name_n; parent tag name_m

The rule of automatically generating the variable name is described below.

Specifying a tag name from the route tag to the parent tag by a path of delimiting it with ‘;’, and The variable names _n and _m indicate the indexes from higher to lower if the tags of the same name are located (n, m are a half-sized character starting from zero).

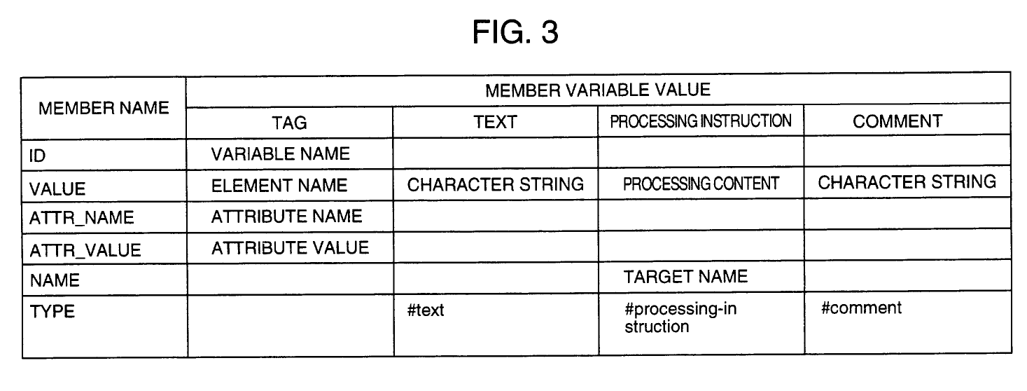

Then, the mapping rules 6 on the member name and the member variable value are described in FIG. 3.

Various kinds of information such as tag, text, processing instruction and comments are treated as more abstract node information and specified as member variable values such as ID, VALUE, ATTR_NAME, ATTR_VALUE, NAME and TYPE. For example, the tag variable name in FIG. 3 is specified as the variable value of the member variable ID. Herein, each of the attribute name and the attribute value may be specified as NAME and VALUE. In consideration of the convenience, they are treated as solid member variables, ATTR_NAME and ATTR_VALUE.

No value is mapped in an empty item in FIG. 3. Further, if a new node is added, the table of FIG. 3 may be expanded for the new node.

Next, the mapping rule 6 on the array index will be described. In this mapping rule 6, the node location corresponds with the array index of the variable in the XML data. That is, the node sequence from higher to lower corresponds with the array index in the same-level nest in a one-to-one correspondence manner.

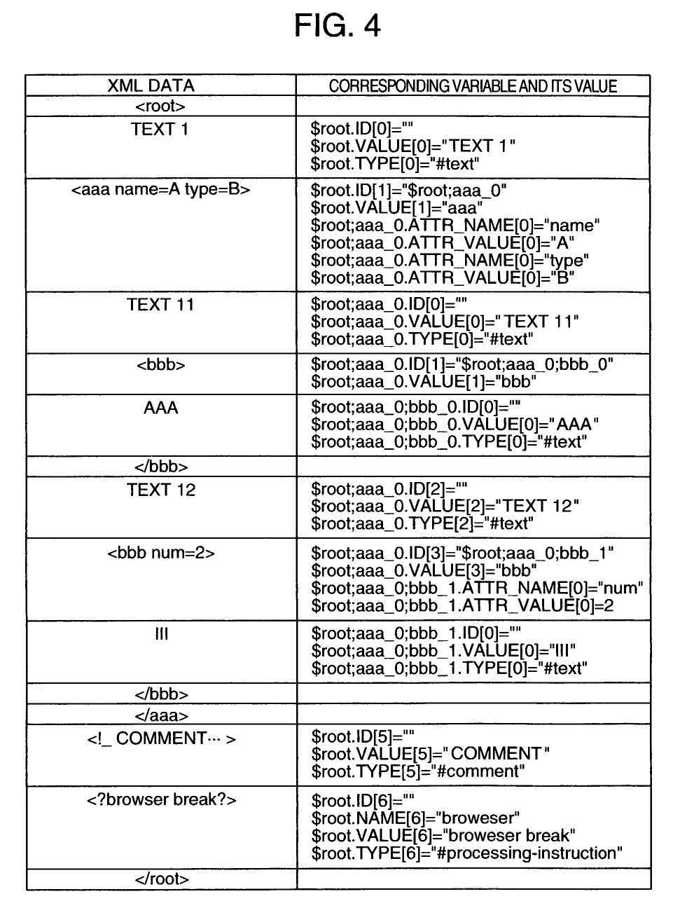

The example of generating the variable for the XML data on the foregoing mapping rules 6 is shown in FIG. 4. In FIG. 4, it is understood that all the node types, node lists, and node data are provided with the unique variable names and values so that they may be corresponded with each node data unit in a one-to-one manner.

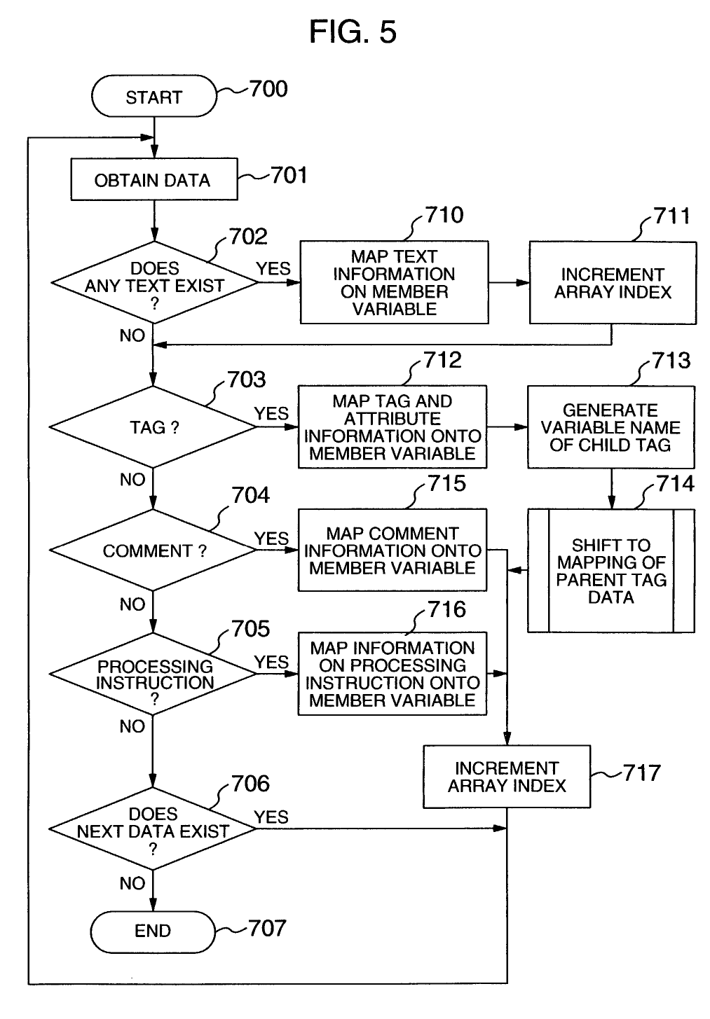

Next, the details of the input mapping function 4 will be described below. The input mapping function is a function of entering XML data, generating information of one tag as a variable according to the mapping rules 6, and specifying the variable value. FIG. 5 is a flowchart showing the input mapping function. In FIG. 5, at first, the process is executed to delimit a character string from a start tag to an end tag of the route tag of the XML data, start the retrieval from its head (step 700), and obtain a character string A to a character ‘<’ and a character string B from a character ‘<’ to another character ‘>’ (step 701). At a time, in the case of obtaining the former character string A, it means that this character string A is text (step 702). Then, the member variable of the text information is mapped (steps 710 and 711). The character string B is any one of a tag, a comment and a processing instruction. The node type is determined as follows: If the character subsequent to the character ‘<’ is a character ‘!’, the character is the commend, if the character subsequent to the character ‘<’ is a character ‘?’, the character is the processing instruction, and if it is any other character, the character is the tag (steps 703, 704, 705). The sequence of determining the node type in the steps 703, 704 and 705 is not limited to that of FIG. 5. The sequence may be reshuffled. The flow of FIG. 5 corresponds with the table of FIG. 3. The expansion of the table of FIG. 3 may correspond with the expansion of the flow of FIG. 5.

For the tag, the process is executed to generate a variable name based on the mapping rule of the variable name (step 713), delimit the character string of the character name from the start tag to the end tag, and recursively invoking the process of the step 700 (step 714) like the route tag. If the member variable is mapped, the array index is incremented (step 717) and then process goes back to the step 701. Lastly, the end determination is executed (step 706). If no data is provided, the process is terminated (step 707).

In turn, the description will be oriented to the method of editing the XML data through the script to be described in the script file. The XML data is edited by entering a variable value in the script ranging from the input mapping function to the output mapping function. The edition of the XML data includes correction, deletion and addition of the data of the node. If this edition is applied to handling of the mapped variable, the correction of the data means change of a variable value, and the deletion of the data means making the value of the node empty. It means that the node with an empty value in the variable array is not allowed to be supplied. If the node is added to the tail, a new variable value is entered to the tail of the array. Further, if the node is added to any other portion rather than the tail, the array element after the location in the array where the node is to be added is shifted one by one so that a variable value may be entered to an empty location.

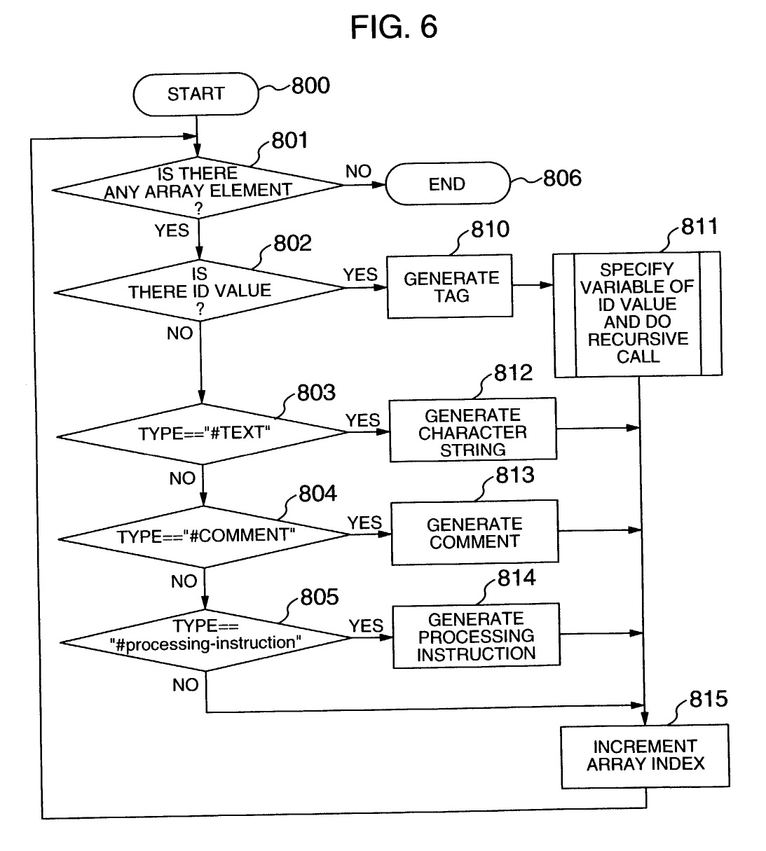

Next, the details of the output mapping function 7 will be described. The output mapping function is a function of creating the XML data from the content of the variable buffer at the invoking time point through the use of the variable information according to the mapping definition rule. FIG. 6 is a flowchart showing the output mapping function.

In FIG. 6, the operation is executed to specify a variable in which the data of the route tag is held and then to start the process (step 800). At first, the termination is determined (step 801). If no array element in the current array index is located, the process is terminated (step 806). If there exists a value of a member variable ID in the variable in which the tag data is held, it means that the variable holds the data of the tag. Hence, the process is executed to generate the tag (step 810), specify a variable name of a parent tag specified as the member variable ID value, and perform a recursive call (step 811). If data except the tag is determined to be located in step 802, the process of determination in the steps 803, 804 and 805 is executed to generate a character string, a comment and a processing instruction (steps 812, 813 and 814). By repeating the foregoing process until no array element is left, it is possible to generate the XML data from the variables and their values according to the mapping rules.

This is the end of the description on the dynamic mapping function. Lastly, the example of the description of the script file will be indicated below.

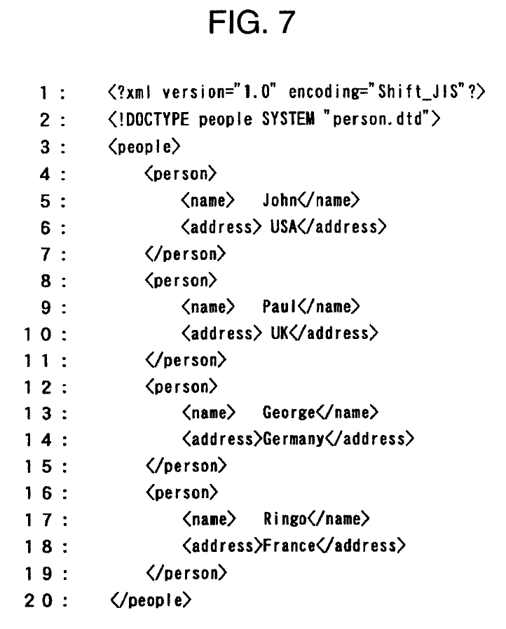

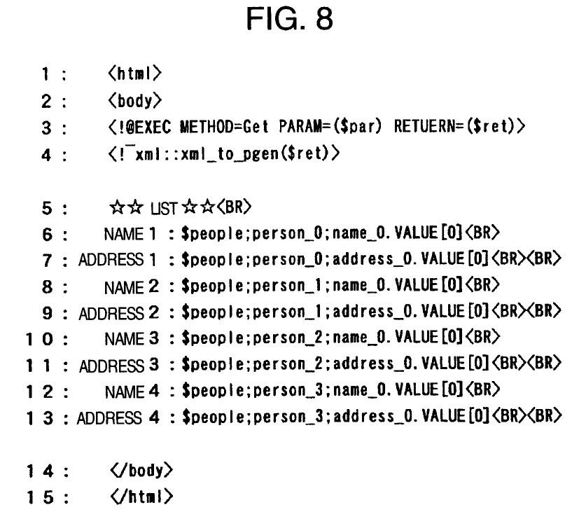

The XML data composed of plural names and addresses is exemplarily shown in FIG. 7. The script file for processing this XML data and supplying the result as the HTML data is shown in FIG. 8. In FIG. 8, the HTML comment tag form script on the third line is an instruction for reading the XML data from the database. Further, the read XML data is stored as the character string data in the variable $ret. Moreover, the HTML comment tag form script on the fourth line is an instruction of specifying the XML data stored in the variable $ret to the variable and its value according to the mapping rules. For example, if the XML data is “<AAA>111</AAA>”, the variable name is “AAA” and the variable value is “111”. That is, the HTML comment tag form script on the fourth line is executed to call the input mapping function. At this time, the mapping data is generated. In the later script or another script file, this mapping data may be used. Then, on the sixth to thirteenth lines, the variable is specified as the display data. As described above, by specifying a variable name on the plane HTML, the script engine is executed to bury a variable value at the location where the variable is specified and then output the HTML file.

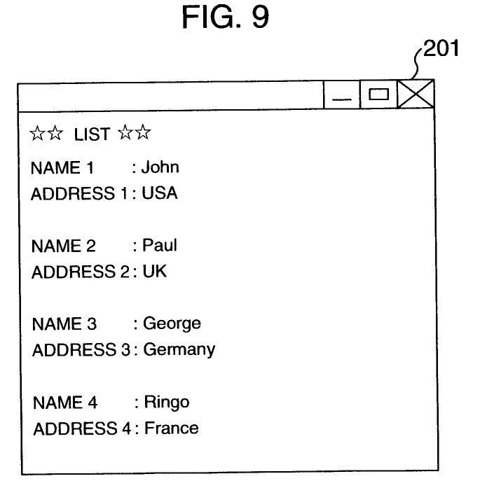

The result of processing the script file of FIG. 8 and supplying the HTML file is displayed like the Web contents 201 of FIG. 9.

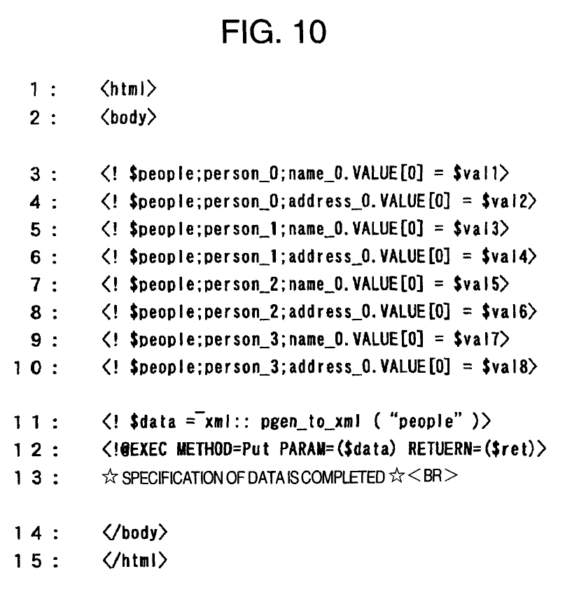

On the other hand, the script file shown in FIG. 10 is a script of displaying the latest data by the script of FIG. 8 and then entering the data on the input field of the browser onto the database. In FIG. 10, the data entered on the input field of the browser is stored as the variables $val1 to $val8 in the variable buffer of the script engine, respectively. Then, in the HTML comment tag form script on the third to the tenth lines, the values of the variable $val1 to $val8 are assigned in the same variables as the mapping data generated in FIG. 8. Afterwards, the variable value specified by the HTML comment tag form script on the eleventh line is converted into the XML data. This script on the eleventh line is a script of calling the output mapping function. At this time, the XML data may be generated by using the mapping data generated in FIG. 8. Lastly, the THML comment tag form script on the twelfth line is executed to output the XML data onto the database.

Like FIGS. 8 and 10, in the Web application where the XML data is obtained from the database and displayed on the browser, the displayed data is changed, and the changed result is given back to the database, no other operation of mapping data rather than the operation of the corresponding variable value is required to be considered. The amount of development of the overall script on the Web application may be suppressed into a minimum level.

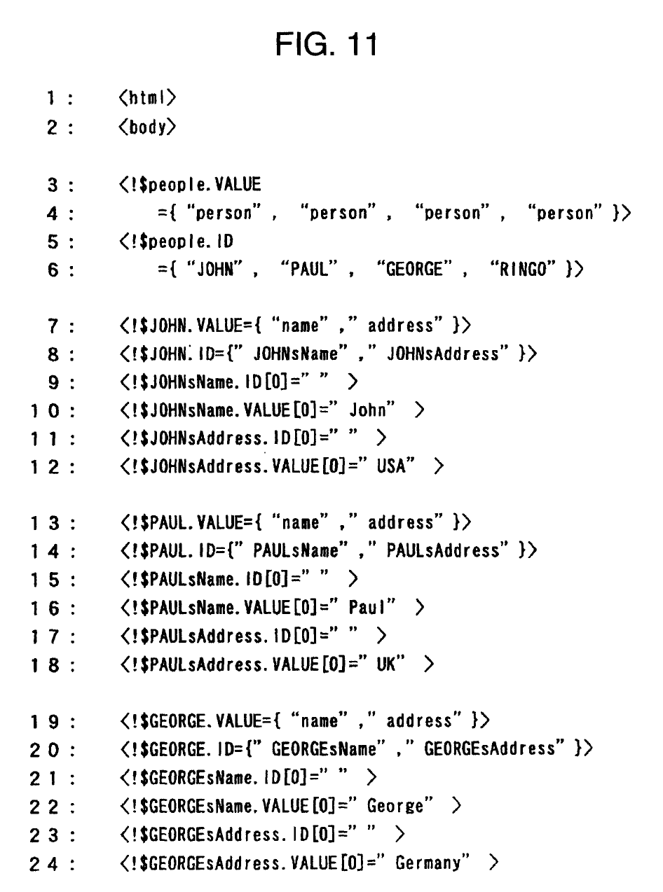

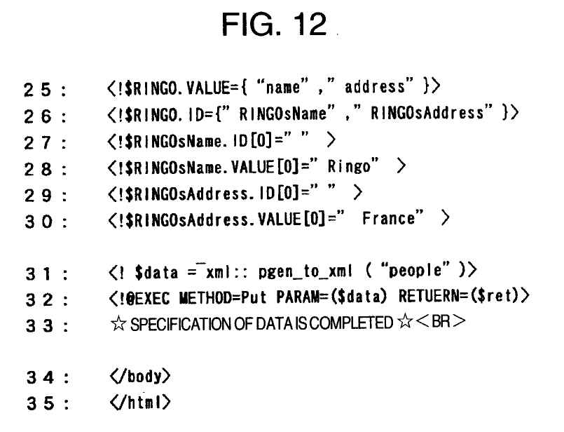

As an example of the last script file, the script file for supplying the XML data of FIG. 7 is shown in FIGS. 11 to 12. The shown case is a description of the mapping data in the script file because of no inputted XML data. In the variable assignment script on the third line shown in FIG. 11, the variable value delimited on the fourth line by a comma is assigned as the variable array values in ascending order. This holds true to the script on the fifth line or later. As described above, the variable assignment script on the third to the 30th lines of FIG. 11 is executed to configure the mapping data. Afterwards, the variable value specified by the script on the 31st line is converted into the XML data and then the XML data is supplied to the database through the effect of the script on the 32nd line. This output XML data is the same content as that of FIG. 7.

The foregoing embodiment makes it possible for the dynamic mapping function to input/output and handle the XML data.

According to the foregoing embodiment, the once generated mapping data may be used for another script file through the effect of the dynamic mapping function. For example, when the script file for displaying the latest XML data on the database is in execution, the mapping data is generated. Then, in the script file of obtaining the changed data from the browser and generating the updated XML data of the database, the generated mapping data may be used. In this case, the output XML data has the same tag arrangement as the input XML data, except only the tag data. Hence, the script is described for only the change of the variable value for the tag data without any change of the mapping data. This makes it possible to reduce the number of steps of creating the script.

On the other hand, if no input XML data is located, no mapping data is automatically generated, so that the mapping data according to the mapping rules is required to be described in the script file. This mapping data may be used in another script file.

Moreover, the aforementioned process may be arranged by the software program. Instead, this mapping data may be stored in the storage medium.

The present invention is effective in processing the general-purpose XML document.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A method for XML data conversion through the use of a computer, comprising the steps of:
extracting, by said computer, data based on a specific character from XML data being inputted; and
converting, by said computer, said extracted data into a variable to be processed by a script language on the basis of the predetermined rules.

2. A method for XML data conversion through the use of a computer, comprising the steps of:
extracting, by said computer, data on a specific character from XML data being inputted; and
storing, by said computer, said extracted data as data composed of a variable name, a member name, an array index, and a value, on the basis of the predetermined rules.

3. A method for XML data conversion as claimed in claim 1, wherein if the tags included in said XML data has a parentage, said rules includes a rule of connecting a character string of a tag name from a tag name of a route tag to that of a parent tag with a delimiter to obtain a variable name corresponding with a child tag.

4. A method for XML data conversion as claimed in claim 1, wherein if the tags included in said XML data includes the same tag name, said rules includes a rule of specifying a character string in which an index is added to the same tag name.

5. A method for XML data conversion as claimed in claim 1, wherein said specific character includes any one of <, >, ! and ?.

6. A method for XML data conversion as claimed in claim 2, wherein said specific character includes any one of <, >, ! and ?.

7. A program for converting XML data into data to be processed by a script language, comprising the steps of:
reading said XML data stored in a recording unit;
converting a variable name for a tag included in said XML data into a variable name to be used by a script language and storing said variable name; and
storing data of said tag included in said XML data as a variable value for said variable name.

8. A program of generating XML data, comprising the steps of:
reading a variable name to be processed by a script language described according to the predetermined rules and a variable value for said variable name from a recording unit; and
generating said XML data based on said variable name and said variable value.

9. A program as claimed in claim 8, wherein if the tags included in said generated XML data has a parentage, said rules includes a rule of specifying a character string composed of a tag name of a route tag and a tag name of a parent tag connected with each other by a delimiter as a variable name for a child tag.

10. A program as claimed in claim 8, wherein if the tags included in said generated XML data has the same tag name, said rules includes a rule of specifying a character string in which an index is added to the same tag name as a variable name.

11. A program of converting XML data into data to be processed by a script language, comprising the steps of:
reading said XML data stored in a recording unit;
determining if said XML data includes text information;
storing said text information as a member variable of a character string to be processed by said script language, based on the result of determining if said text information is included;
determining if said XML data is included in tag information;
storing a tag name included in said tag information as a member variable of a variable name to be processed by said script language, based on the result of determining if said tag information is included;
determining if comment information is included in said XML data;
storing said comment information as a member variable of a character string to be processed by said script language, based on the result of determining if said comment information is included;
determining if said XML data includes information on a processing instruction; and
storing information on said processing instruction as a member variable of a content to be processed by said script language.
